(19) United States
(12) Patent Application Publication
(10) Pub. No.: US 2004/0026940 A1
(43) Pub. Date: Feb. 12, 2004

(54) Interlocking barbecue cooking tool

(76) Inventors: Andrew Kahler, Fortson, GA (US); Ryan Neal, Midland, GA (US); Scott Dobias, Columbus, GA (US); Kenneth Jordan, Columbus, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/215,550

(22) Filed: Aug. 8, 2002

(51) Int. Cl. A47J 43/28

(52) U.S. Cl. 294/7

(57) ABSTRACT

An interlocking cooking tool for use when grilling comprises a utensil having a handle with a first and second end, a tool head extending from the first end of the handle, and an interlocking connector extending from the second end of the handle. The utensil is configured to be releasably interlocked with a second utensil configured with an interlocking connector, such that the first utensil and second utensil when interlocked may be used as tongs. A method is also provided.

### TECHNICAL FIELD

The present invention is generally related to cooking tools for use with barbecue grills and more particularly, is related to an interlocking cooking tool.

### BACKGROUND OF THE INVENTION

Barbecue grills can be used to cook various types of foods, including vegetables and meat, including beef, chicken, fish, pork, etc. Barbecue grills typically comprise a firebox having a cooking surface suspended or supported therein over a source of heat. The cooking surface typically comprises a grate. Cooking generally requires the use of various utensils for handling and cooking the food. In particular, grilling commonly uses the same four to six utensils, regardless of whether the grill is being used to cook meats or vegetables.

Grilling is as widespread and popular as any other form of cooking. Grills can be heated by gas, charcoal, or electricity and can be used indoors or outdoors. Regardless of how or where the food is grilled, the selected heat source for the grill, or with which heat source the user grills, the user will need a plurality of utensils to handle and cook the food and to care for the grill. These utensils can include, for example, a spatula to flip or turn the food product; tongs to handle the food, such as for removal or placement of the food products onto the grill; a fork for manipulating the food product; a brush for brushing on barbecue sauce, or the like; and a scraper or brush for cleaning residue off the grill before and after cooking. It is desirable that the tools used while grilling include a somewhat elongated handle such that the user can keep a reasonable distance from the heat while working with the food or cleaning the cooking surface. These tools are awkward and space consuming to store and transport. As such, grilling requires the care, maintenance and keeping track of a variety of tools and utensils that are usually relatively large and unwieldy, and it is desirable to use, maintain, and transport as few tools as possible when using a barbecue grill.

Thus, a heretofore unaddressed need exists in the industry to address the aforementioned deficiencies and inadequacies.

### SUMMARY OF THE INVENTION

Preferred embodiments of the present invention provide an interlocking cooking tool for use when grilling. Briefly described, in architecture, one embodiment of the cooking tool can be implemented as follows. An interlocking cooking tool for use when grilling comprises a utensil having a handle with a first and second end, a tool head extending from the first end of the handle, and an interlocking connector extending from the second end of the handle. The utensil is configured to be releasably interlocked with a second utensil configured with an interlocking connector, such that the first utensil and second utensil when interlocked may be used as tongs.

Preferred embodiments of the present invention can also be viewed as providing a method of cooking food on a grill. In this regard, one embodiment of such a method, among others, can be broadly summarized by the following steps: providing a first cooking utensil for cooking food on a grill; providing a second cooking utensil for cooking food on a grill; and interlockingly connecting the first cooking utensil to the second cooking utensil to form a third cooking utensil.

Other systems, method, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a bottom view of an exemplary embodiment of a cooking utensil of an embodiment of the interlocking cooking tool of the present invention.

FIG. 2 is a side view of the cooking utensil illustrated in FIG. 1.

FIG. 3 is a top view of an exemplary embodiment of an exemplary second cooking utensil of an embodiment of the interlocking cooking tool of the present invention.

FIG. 4 is a side view of the second cooking utensil illustrated in FIG. 3.

FIG. 5 is a side view of an embodiment of the interlocking cooking tool of the present invention implementing the exemplary cooking utensil of FIG. 1 and the exemplary second cooking utensil of FIG. 3.

### DETAILED DESCRIPTION OF THE PREFERRED EMBODIMENTS

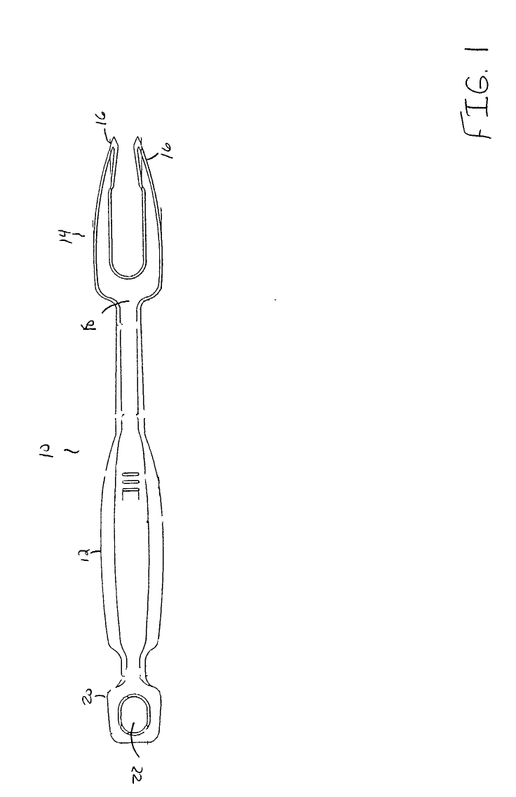

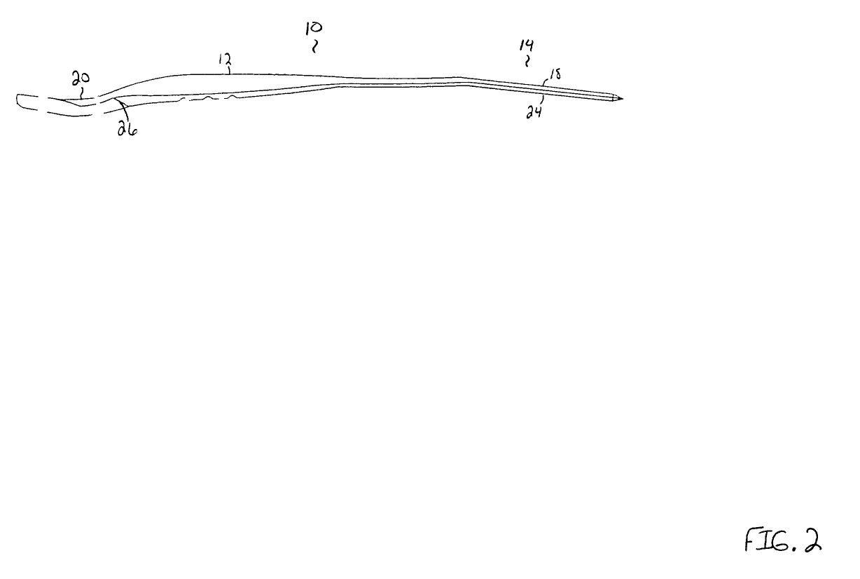

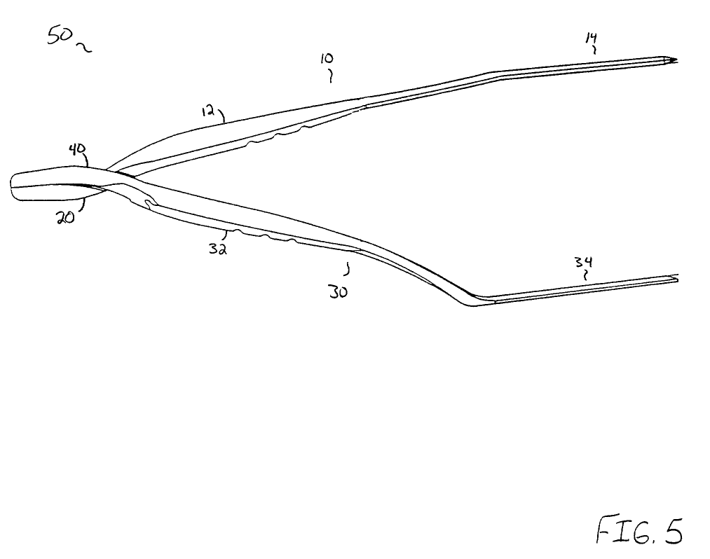

FIG. 1 illustrates one embodiment of a cooking utensil 10 of the interlocking cooking tool 50 (FIG. 5) of the present invention. The preferred cooking utensil 10 generally comprises a handle 12 having a tool head 14 extending therefrom. The preferred cooking utensil 10 is generally elongated in shape, with a longitudinal axis disposed along the length of the cooking utensil 10. In the preferred embodiment, the cooking utensil 10, and components thereof, will also generally have an upper surface 24 (FIG. 2) and a lower surface 18. The preferred handle 12 is substantially elongated and defined by a first end and second end. The preferred handle 12 is substantially arcuate in shape and preferably comprises a substantially rigid material, such as a hard plastic, hard rubber, metal, or any suitable material.

In some embodiments, the first end of the handle 12 will directly attach to the tool head 14 as depicted in FIG. 1. In other embodiments, the handle 12 may be separated from the tool head 14 by a throat portion. The throat portion of these alternative embodiments is preferably a substantially rigid material, such as a hard plastic, hard rubber, metal, or any suitable material. Additionally, the throat portion may be constructed of the same material as the handle 12, but is not required to be the same material.

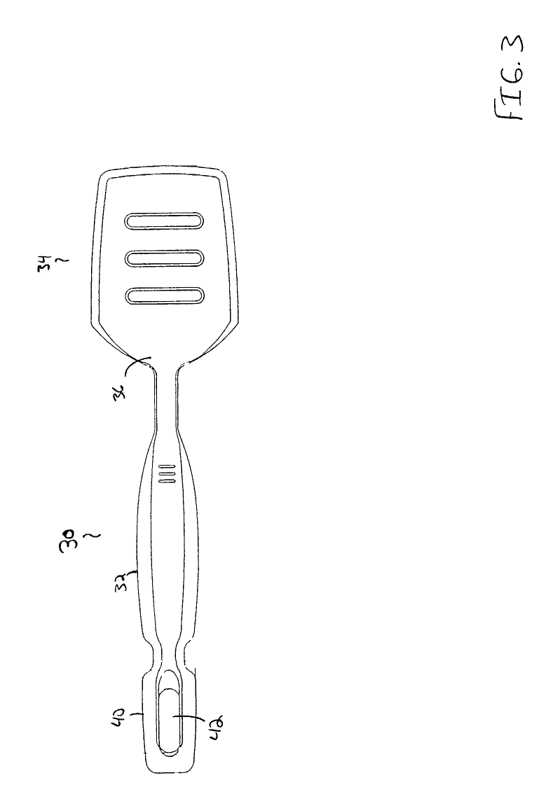

The tool head 14 is disposed toward the first end of the handle 12. The tool head 14 may be of a variety of shapes in various embodiments, including a spatula (FIG. 3), or a fork (FIG. 1), or other appropriate shapes. FIG. 1 illustrates one embodiment of the cooking utensil 10 implementing a fork tool head 14. As depicted in FIG. 1, the preferred fork tool head 14 is provided with a plurality of tines 16. In the embodiment depicted in FIG. 1, two tines 16 are implemented, however, in other embodiments, additional tines 16 may be implemented in the fork tool head 14.

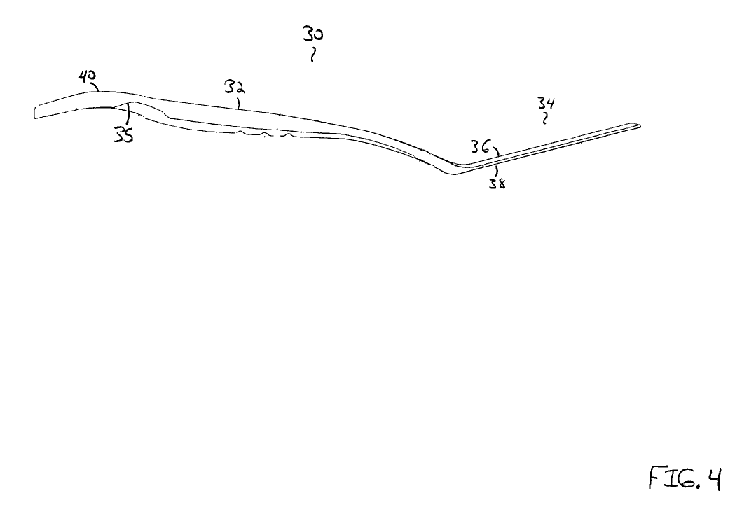

In the preferred embodiment, the cooking utensil 10 will be configured to be releasably interlocked to a second cooking utensil 30 (FIG. 4) to form an embodiment of the interlocking cooking tool 50 (FIG. 5). As would be known to one of ordinary skill in the art, there are various ways the releasable interlocking connection may be implemented, and all such implementations are intended to be within the scope of the present invention. One preferred embodiment of a detachable connection will be described below with respect to FIGS. 1, 3, and 5. This preferred embodiment is in no way intended to limit the scope of the present invention, and is merely presented as an illustration of one implementation of the releasable interlocking connection.

In the preferred embodiment illustrated in FIG. 1, the handle 12 of the cooking utensil 10 is further configured with an endpiece 20 extending from the second end of the handle 12. In the preferred embodiment, the endpiece 20 is an integral part of the handle 12, extending away from the handle 12 at the opposite end of the handle 12 from the tool head 14. In other embodiments, the endpiece 20 may be a separate component, either permanently or detachable affixed to the second end of the handle 12.

As illustrated in FIG. 2, the preferred embodiment of the endpiece 20 is curved in an s-shape, first extending upwardly from the upper surface 24 of the cooking utensil 10 at the second end of the handle 12, and then curving to extend towards the lower surface 18 of the cooking utensil 10. As also illustrated in FIG. 2, the preferred endpiece 20 has a side portion 26. The endpiece 20 is preferably a substantially rigid material, such as a hard plastic, hard rubber, metal, or any suitable material. Additionally, preferred endpiece 20 may be constructed of the same material as the handle 12, but is not required to be the same material.

Returning to FIG. 1, the preferred endpiece 20 further includes a male portion 22 for forming the releasable interlocking connection as described below. In the preferred embodiment, the male portion 22 extends outwardly from the lower surface 18 of the endpiece 20. In the preferred embodiment depicted in FIG. 1, the male portion 22 is an integral part of the endpiece 20. However, in other embodiments, the male portion 22 may be a separate component attached to the lower surface 18 of the endpiece 20. As would be known to one of ordinary skill in the art, there are various ways, methods, or mechanisms by which such a male portion 22 could be attached to the endpiece 20, and all such ways, methods, or mechanisms are intended to be within the scope of the present invention.

As illustrated in FIG. 1, the preferred male portion 22 may be substantially oval in shape. In other embodiments, the male portion 22 may be any of a variety of shapes, including square, rectangular, diamond shaped, triangular, polygonal, etc.

FIG. 3 illustrates an embodiment of a second cooking utensil 30 of the combination grill tool 50 (FIG. 5) of the present invention. The preferred second cooking utensil 30 may be similar in several respects to the cooking utensil 10 illustrated in FIG. 1. The second cooking utensil 30 and cooking utensil 10 may be the same type, i.e. both being spatulas, forks, etc., or may be different types.

As with the embodiment of the cooking utensil 10 illustrated in FIG. 1, the preferred second cooking utensil 30 generally comprises a handle 32 having a tool head 34 extending therefrom. The second cooking utensil 30, and components thereof, generally have an upper surface 36 and a lower surface 38 (FIG. 4).

As illustrated in FIG. 3, the preferred handle 32 is substantially elongated and defined by a first end and second end. The preferred handle 32 is substantially arcuate in shape and preferably comprises a substantially rigid material, such as a hard plastic, hard rubber, metal, or any suitable material. In some embodiments, as illustrated in FIG. 3, the first end of the handle 32 will directly attach to the tool head 34. In other embodiments, the handle 32 may be separated from the tool head 34 by a throat portion. The throat portion of these alternative embodiments is preferably a substantially rigid material, such as a hard plastic, hard rubber, metal, or any suitable material. Additionally, the throat portion may be constructed of the same material as the handle 32, but is not required to be the same material.

The preferred tool head 34 of the second cooking utensil 30 is disposed toward the first end of the handle 32. The tool head 34 may be of a variety of shapes in various embodiments, including a spatula, or a fork (FIG. 1), or other appropriate shapes. FIG. 3 illustrates one embodiment implementing a spatula tool head 34. In the preferred embodiment of the spatula illustrated in FIG. 3, the spatula tool head 34 is substantially rectangular in shape. It should be understood that although the tool head 34 of FIG. 3, is illustrated as being substantially rectangular, the tool head 34 can comprise any suitable shape.

In the preferred embodiment, the second cooking utensil 30 will be configured to be releasably interlocked to the first cooking utensil 10 to form an embodiment of the interlocking cooking tool 50 (FIG. 5). In the embodiment illustrated in FIG. 3, the handle 32 of the second cooking utensil 30 is further configured with a second endpiece 40 extending from the second end of the handle 32. As depicted in FIG. 3, the preferred second endpiece 40 is an integral part of the handle 32, extending away from the handle 32 at the opposite end of the handle 32 from the tool head 34. In other embodiments, the second endpiece 40 may be a separate component, either permanently or detachably affixed to the second end of the handle 32.

As further illustrated in FIG. 4, the preferred embodiment of the second endpiece 40 is curved in an s-shape, first extending upwardly from the upper surface 36 of the second cooking utensil 30 at the second end of the handle 32, and then curving to extend towards the lower surface 38 of the second cooking utensil 30. As also illustrated in FIG. 4, the preferred second endpiece 40 has a side portion 35. The second endpiece 40 is preferably a substantially rigid material, such as a hard plastic, hard rubber, metal, or any suitable material. Additionally, preferred second endpiece 40 may be constructed of the same material as the handle 32, but is not required to be the same material.

Returning to FIG. 3, the preferred second endpiece 40 further includes a female portion 42 for forming the releasable interlocking connection as described below. In the preferred embodiment, the female portion 42 is an elongated aperture disposed through the second endpiece 40. As discussed below, the preferred aperture comprising the female portion 42 is configured to receive the male portion 22 (FIG. 1) of the cooking utensil 10, providing an embodiment of the detachable connection between the second cooking utensil 30 and the cooking utensil 10 (FIG. 1), and forming an embodiment of the interlocking cooking tool 50 (FIG. 5).

As discussed above with respect to FIG. 1, the preferred male portion 22 may be substantially oval in shape. In other embodiments, the male portion 22 may be any of a variety of shapes, including square, rectangular, diamond shaped, triangular, polygonal, etc. Similarly, the preferred aperture of the female portion 42 of the embodiment of the second endpiece 40 illustrated in FIG. 3, may also be substantially oval, rectangular, diamond shaped, triangular, polygonal, etc., depending on, and corresponding to the implemented shape of the male portion 22 (FIG. 1).

FIG. 5 illustrates one embodiment of the interlocking cooking tool 50 of the present invention. As shown in FIG. 5, an embodiment of a cooking utensil 10 is releasably interlocked with an embodiment of a second cooking utensil 30 to form an interlocking cooking tool 50 capable of manipulating food in a manner that may not be accomplished through use of either the cooking utensil 10 or second cooking utensil 30 separately.

In the preferred embodiment depicted in FIG. 5, the male portion 22 (not shown in FIG. 5) of the first endpiece 20 of the cooking utensil 10 is disposed through the female portion 42 (not shown in FIG. 5) of the second endpiece 40 of the second cooking utensil 30, releasably interlocking the cooking utensil 10 and second cooking utensil 30. Further, in the embodiment depicted in FIG. 5, the side portion 26 (not shown in FIG. 5) of the cooking utensil 10 abuts the side portion 35 (not shown in FIG. 5) of the second cooking utensil 30, helping to secure connection between the cooking utensil 10 and second cooking utensil 30 into the configuration depicted in FIG. 5.

In the preferred embodiment illustrated in FIGS. 1, 3, and 5, the cooking utensil 10 and second cooking utensil 30 may be releasably interlocked by rotating either cooking utensil 10 or second cooking utensil 30 with respect to the other, and by twisting the cooking utensil 10 about its longitudinal axis. The male portion 22 is then interlocked with the female portion 42 by inserting the male portion 22 into the female portion 42 while simultaneously twisting and rotating the cooking utensil 10 until the side portion 26 of the cooking utensil 10 rests against the side portion 35 of the second cooking utensil, and the cooking utensil 10 and second cooking utensil 30 are substantially in the same plane as illustrated in FIG. 5. These steps may be reversed to detach the cooking utensil 10 from the second cooking utensil 30 to allow separate use of cooking utensil 10 and/or second cooking utensil 30.

When connected in the preferred embodiment illustrated in FIG. 5, the connection between the endpiece 20 of the cooking utensil 10, and the preferred second endpiece 40 of the second cooking utensil 30, also serves to provide a fulcrum. This fulcrum allows this embodiment of the interlocking cooking tool 50 to be used in the manner of tongs, wherein a user may grasp handle 12 and handle 32 in one hand, and by applying pressure to the handles 12, 32, the user may grasp and/or manipulate food or other objects between the tool head 14 of the cooking utensil 10 and the tool head 34 of the second cooking utensil 30.

When such pressure is applied to handle 12 and handle 32, the configuration of the preferred embodiment of the endpiece 20 and second endpiece 40 operates to apply a separating force between the endpiece 20 and the second endpiece 40 at the point of the interlocking connection. This separating force in turn applies pressure between the part of the male portion 22 overlapping the second endpiece 40, serving to further secure the interlocking connection when the interlocking cooking tool 50 is used to grasp objects as described above.

The resistance provided by the preferred shape and material of the endpiece 20 and the preferred shape and material of the second endpiece 40 also serves to separate the tool head 14 of the cooking utensil 10 and the second tool head 34 of the second cooking utensil 30 when the user ceases applying pressure to handle 12 and handle 32.

In this manner, in the preferred embodiment, may use the fork cooking utensil 10 and/or spatula utensil 30 separately for some uses, and then when desired, may interlock the two cooking utensils 10, 30 to form a third interlocking cooking tool 50 performing some functions not readily available by use of the cooking utensils 10, 30 separately.

The embodiment depicted in FIGS. 1-5 illustrate one preferred embodiment of the interlocking cooking tool 50 of the present invention. Other embodiments would be known to one of ordinary skill in the art and are intended to be within the scope of the present invention. For example, in alternative embodiments, both cooking utensils 10, 30 may be spatula-type utensils. In other embodiments, both cooking utensils 10, 30 may be spatula-type utensils. In yet other embodiments, one or both of the cooking utensils 10, 30 may be other types of utensils capable of being combined to operate together as described above, as would be known to one of ordinary skill in the art.

Similarly, other ways and methods of releasably interlocking two cooking utensils 10, 30 may be implemented in alternative embodiments of the present invention. By way of example, the releasable interlocking connection could be performed by inserting the second end of the handle 12 of the cooking utensil 10 into an aperture disposed in the handle 32 of the second cooking utensil 30 and securing it in some fashion, such as with a pin or latch, or by use of other interlocking means or methods that would be known to one of ordinary skill in the art.

Accordingly, it should be emphasized that the above-described embodiments of the present invention, particularly, any “preferred” embodiments, are possible examples of implementations, merely set forth for a clear understanding of the principles of the present invention. Many variations and modifications may be made to the above-described embodiments(s) of the invention without department substantially from the spirit and principles of the invention. All such modifications and variations are intended to be included herein within the scope of this disclosure and the present invention and protected by the following claims.

Therefore, having thus described the invention, at least the following is claimed:

1. A cooking tool, comprising:
a first cooking utensil, said first cooking utensil comprising:
a handle having a first end and a second end;
a tool head having an upper surface and a lower surface, said tool head extending from the first end of said handle;
wherein the first cooking utensil is configured to be used alone and is further configured to be releasably interlocked with a second cooking utensil to form cooking tongs.

2. The cooking tool of claim 1, wherein the first cooking utensil further comprises an endpiece extending outwardly from the second end of the handle.

3. The cooking tool of claim 4, further comprising:
a second cooking utensil, the second cooking utensil comprising:
a handle having a first end and a second end;
a tool head having an upper surface and a lower surface, said tool head extending from the first end of said handle; and
a releasable interlocking connection between the first cooking utensil and the second cooking utensil, such that when the first cooking utensil is interlocked with the second cooking utensil, the tool head of the first cooking utensil and the tool head of the second cooking utensil will operate together to grasp or manipulate objects.

4. The cooking tool of claim 3, wherein the releasable interlocking connection further comprises:
a male portion disposed on the endpiece of the first cooking utensil; and
a female portion aperture disposed in the second endpiece of the second cooking utensil;
wherein the male portion and the female portion aperture are configured such that the male portion may be releasably received within the female portion aperture.

5. The cooking tool of claim 4, wherein the endpiece and second endpiece are configured to provide a fulcrum between the fist cooking utensil and second cooking utensil.

6. The cooking tool of claim 4, wherein the endpiece and second endpiece are configured such that when the first cooking utensil and second cooking utensil are interlocked, and when a user manipulates the first cooking utensil and second cooking utensil as tongs, resistance is provided.

7. The cooking tool of claim 8, wherein the male portion is received in the female portion aperture by rotating and twisting said cooking utensils to releasably interlock the male portion into the female portion aperture.

8. A method for cooking food on a grill, the method comprising:
providing a first cooking utensil for cooking food on a grill;
providing a second cooking utensil for cooking food on a grill; and
interlockingly connecting the first cooking utensil to the second cooking utensil to form a third cooking utensil for use in manipulation the food on the grill.

9. The method of claim 8, wherein the third cooking utensil comprises cooking tongs.

10. The method of claim 9, wherein the first cooking utensil further includes a handle configured with an endpiece; and wherein the second cooking utensil further includes a handle configured with a second endpiece.

11. The method of claim 10, wherein the step of interlockingly connecting the first cooking utensil to the second cooking utensil further comprises the step of interlocking the endpiece of the first cooking utensil to the second endpiece of the second cooking utensil to form a fulcrum.

12. The method of claim 11, wherein the step of interlocking connecting the first cooking utensil to the second cooking utensil further includes providing resistance between the first cooking utensil and the second cooking utensil when the first cooking utensil and second cooking utensil are connected to form cooking tongs.

13. The method of claim 12, wherein the endpiece of the first cooking utensil and the second endpiece of the second cooking utensil are configured to provide a fulcrum between said utensils.
